(19) United States
(12) Patent Application Publication
(10) Pub. No.: US 2019/0009831 A1
(43) Pub. Date: Jan. 10, 2019

(54) ACTIVELY DEPLOYABLE AND RETRACTABLE FENDER SKIRTS FOR INCREASED FUEL EFFICIENCY

(71) Applicant: International Business Machines Corporation, Armonk, NY (US)

(72) Inventors: Chad M. ALBERTSON, Rochester, MN (US); Eric J. CAMPBELL, Rochester, MN (US); Nicholas J. OLLERICH, Rochester, MN (US); Christopher W. STEFFEN, Rochester, MN (US)

(21) Appl. No.: 15/644,446

(22) Filed: Jul. 7, 2017

(51) Int. Cl. B62D 25/18; F16D 66/00

(52) U.S. Cl. CPC B62D 25/182; F16D 66/00; F16D 2066/001; G01C 21/36; B60Y 2400/303; B60Y 2400/302; B60Y 2400/3032

(57) ABSTRACT

A vehicle with deployable pliable fairing skirts and a controller for controlling deployment of the skirts are provided. The pliable fairing skirts are deployable over openings of wheel wells for the vehicle to provide additional streamlining for the vehicle. The pliable fairing skirts are stowable when the brakes of the vehicle may benefit from additional cooling airflow. The skirts are also stowable when environmental conditions may result in damage to the skirts or when steerable wheels of the vehicle would protrude from the opening.

### BACKGROUND

The present disclosure relates to aerodynamic fairings for vehicles, and more specifically, to aerodynamic fairings that are selectively deployable and retractable.

### SUMMARY

In one embodiment, a vehicle comprises a fairing that includes an outward-facing surface and defines a wheel well, wherein an opening in the fairing forms a pathway between the outward-facing surface and the wheel well. The vehicle further comprises a wheel disposed in the wheel well, wherein the wheel is operatively connected to a brake, and wherein the wheel is rotatable about a rotation axis to move the vehicle. The vehicle further comprises a pliable fairing skirt that is movable between a stowed state and a deployed state, wherein the pliable fairing skirt is stored above the opening and behind the outward-facing surface of the fairing in the stowed state, and wherein the pliable fairing skirt covers at least a portion of the opening in the deployed state. The vehicle further comprises an actuator operable to move the pliable fairing skirt between the stowed state and the deployed state. The vehicle further comprises a brake temperature sensor operable to detect temperatures of the brake. The vehicle further comprises a controller in communication with the actuator and with the brake temperature sensor, wherein the controller is operable to move the pliable fairing skirt from the deployed state toward the stowed state upon receiving a signal from the brake temperature sensor indicating a brake temperature that exceeds a temperature threshold.

In another embodiment, a controller is operable to selectively deploy a pliable fairing skirt over an opening for wheel well in a vehicle fairing. The controller comprises a first input operable to receive temperature signals from a brake temperature sensor. The controller further comprises an output operable to transmit control signals to the pliable fairing skirt to cause the pliable fairing skirt to move toward a deployed state and a stowed state. The controller further comprises a computer processor and computer memory storing an application that, when executed by the computer processor, performs an operation, comprising: comparing a temperature indicated by the temperature signals to a threshold temperature, and outputting control signals to cause the pliable fairing skirt to move from the deployed state toward the stowed state upon the temperature indicated by the temperature signals exceeding the threshold temperature.

### BRIEF DESCRIPTION OF THE SEVERAL VIEWS OF THE DRAWINGS

FIG. 1A is a side view of a vehicle according to one embodiment;

FIG. 1B is a side view of the vehicle of FIG. 1A, wherein pliable fender skirts are deployed over wheel well openings;

FIG. 2 is a side view of a wheel well of the vehicle of FIG. 1A, illustrating one embodiment of a mechanism for moving the pliable fender skirt;

FIG. 3 is a side view of a wheel well of the vehicle of FIG. 1A, illustrating a second embodiment of a mechanism for moving the pliable fender skirt;

FIG. 4 is a block diagram of a controller, according to one embodiment, for controlling movement of a pliable fender skirt;

FIG. 5A is a top schematic view of a steerable wheel of the vehicle of FIG. 1A oriented in a straight position;

FIG. 5B is a side view of the wheel well of the vehicle of FIG. 1A, wherein the steerable wheel in the wheel well is oriented in the straight position illustrated in FIG. 5A, and wherein the fender skirt is fully deployed;

FIG. 5C is a top schematic view of the steerable wheel of the vehicle of FIG. 1A oriented in a first turned position;

FIG. 5D is a side view of the wheel well of the vehicle of FIG. 1A, wherein the steerable wheel in the wheel well is oriented in the first turned position illustrated in FIG. 5C, and wherein the fender skirt is partially deployed;

FIG. 5E is a top schematic view of the steerable wheel of the vehicle of FIG. 1A oriented in a second turned position, wherein the second turned position is greater than the first turned position;

FIG. 5F is a side view of the wheel well of the vehicle of FIG. 1A, wherein the steerable wheel in the wheel well is oriented in the second turned position illustrated in FIG. 5E, and wherein the fender skirt is partially deployed to a lesser degree than in FIG. 5D.

### DETAILED DESCRIPTION

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Vehicles, such as automobiles, are designed to be aerodynamically streamlined to improve fuel efficiency. Streamlining reduces drag such that the vehicle requires less power (and therefore less fuel or energy) to move at a particular speed. Certain aspects of a vehicle detract from streamlining. For example, vehicle wheel wells that house the wheels of the vehicle add drag to otherwise streamlined fairings (e.g., fenders). In some instances, fairing skirts can cover the openings to the wheel wells and blend with surrounding portions of the streamlined fairings. However, such fairing skirts are not always advantageous. For example, open wheel wells allow for airflow circulation to brakes for cooling purposes, and such fairing skirts may block the airflow. As another example, in certain environmental conditions, such as when snow has accumulated on roadways or when a vehicle is traveling on muddy roads, dirt roads, or gravel roads, the fairing skirts may be damaged. As another example, fender skirts generally cannot be applied over the openings to wheel wells for steerable wheels of the vehicle because the steerable wheels typically protrude through the opening when pivoted for steering purposes.

In embodiments described herein, pliable fairing skirts (also referred to herein as “pliable fender skirts”) are provided for the wheel wells of a vehicle, such as an automobile, bus, or truck. The pliable fender skirts are movable between a stowed state, in which the wheel wells are open) and a deployed state, in which the pliable fender skirt at least partially covers the opening in a fairing to improve the aerodynamics of the vehicle. The pliable fender skirts are selectively movable from the deployed state toward the stowed state in the event the brakes of the vehicle need to be cooled or in the event the vehicle is traveling in an environment that can cause damage to the pliable fender skirts. Additionally, for the steerable wheels of the vehicle, the pliable fender skirts are movable from the deployed state toward the stowed state when the steerable wheels are pivoted such that the pliable fender skirts do not contact the portion of the steerable wheels protruding from the wheel wells through the openings. As a result, the vehicle that includes the pliable fender skirts can have improved aerodynamic characteristics.

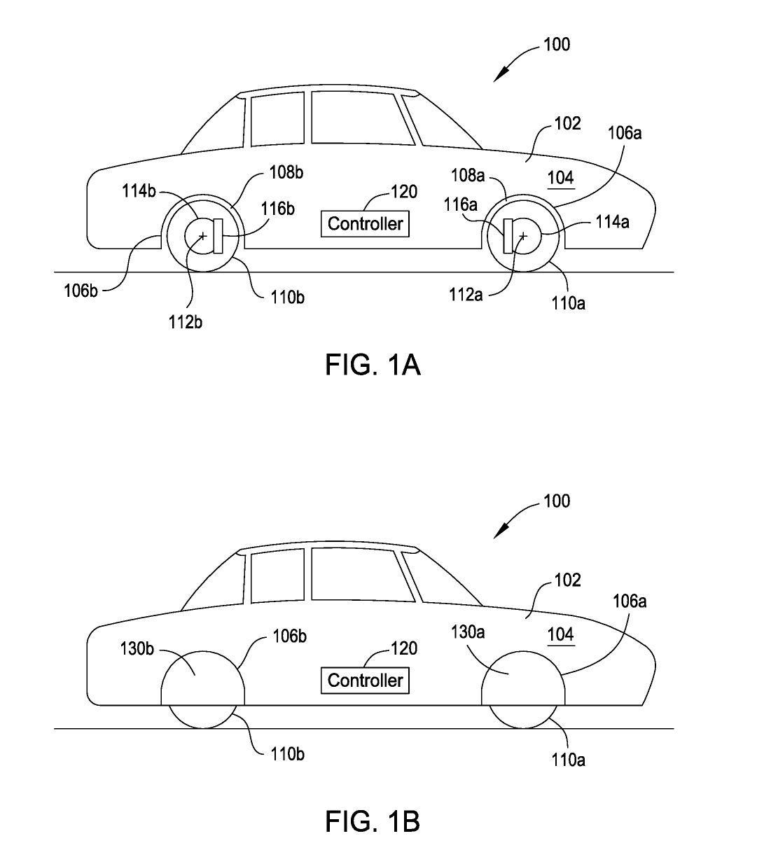

FIGS. 1A and 1B are side views of a vehicle 100, according to one embodiment, that includes a front wheel well 106a and a rear wheel well 106b. The wheel wells 106 are defined by a fairing 102. In the exemplary embodiment, the fairing 102 of the vehicle 100 comprises fenders and other exterior body panels of the vehicle 100. The fairing 102 includes an outward-facing surface 104, and openings 108 in the fairing 102 for a pathway between the outward-facing surface 104 and the wheel wells 106. For example, a front opening 108a forms a pathway between the outward-facing surface 104 and the front wheel well 106a and a rear opening 108B forms a pathway between the outward-facing surface 104 and the rear wheel well 106b.

The front wheel well 106a includes a front wheel 110a disposed therein and the rear wheel well 106b includes a rear wheel 110b disposed therein. The front wheel 110a rotates about a first rotation axis 112a and the rear wheel 110b rotates about a second rotation axis 112b to move the vehicle 100. The front wheel 110a includes a front brake rotor 114a and brake caliper 116a and the rear wheel 110b includes a rear brake rotor 114b and brake caliper 116b. The brake calipers 116 can clamp onto the respective brake rotors 114 to slow the vehicle 114. The friction resulting from the brake calipers 116 clamping onto the respective brake rotors 114 generates heat.

Referring primarily to FIG. 1B, the vehicle 100 includes pliable fairing skirts 130 that cover the openings 108 to the wheel wells 106. The vehicle 100 includes a front pliable fairing skirt 130a that covers the opening 108a of the front wheel well 106a and a rear pliable fairing skirt 130b that covers the opening 108b of the rear wheel well 106b. When deployed, the pliable fairing skirts 130 prevent air from flowing into or out of the wheel wells 106 through the openings 108, which can cause drag. As a result, the overall drag on the vehicle is reduced and the aerodynamics of the vehicle 100 are improved. The vehicle 100 includes a controller 120 that is operable to move the pliable fairing skirts 130 between the deployed state, illustrated in FIG. 1B, and the stowed state, illustrated in FIG. 1A. For example, the controller 120 may be in communication with a brake temperature sensor that detects temperatures of the brake rotors 114 and/or the brake calipers 116. In the event the detected temperatures exceed a temperature threshold, then the controller 120 can communicate command signals to actuators that cause the pliable fairing skirts 130 to move from the deployed state toward the stowed state. As a result, air may flow through the openings 108 of the wheel wells 106 to cool the brake rotors 114 and/or the brake calipers 116.

In at least one embodiment, the pliable fairing skirts 130 comprise a pliable material, such as one of a rubber sheet, a Kevlar sheet, or a plastic sheet. The use of the term “pliable” includes any material that can be stretched, folded, rolled, or otherwise deformed. The use of pliable fairing skirts 130 enables the fender skirts 130 to substantially cover the openings 108 of the wheel wells 106 when in the deployed states but to occupy a relatively small volume or space when in the stowed states. For example, the pliable fender skirts 130 may be stowed in a small volume above the wheel wells 106 or at the top of the wheel wells 106 when in the stowed states.

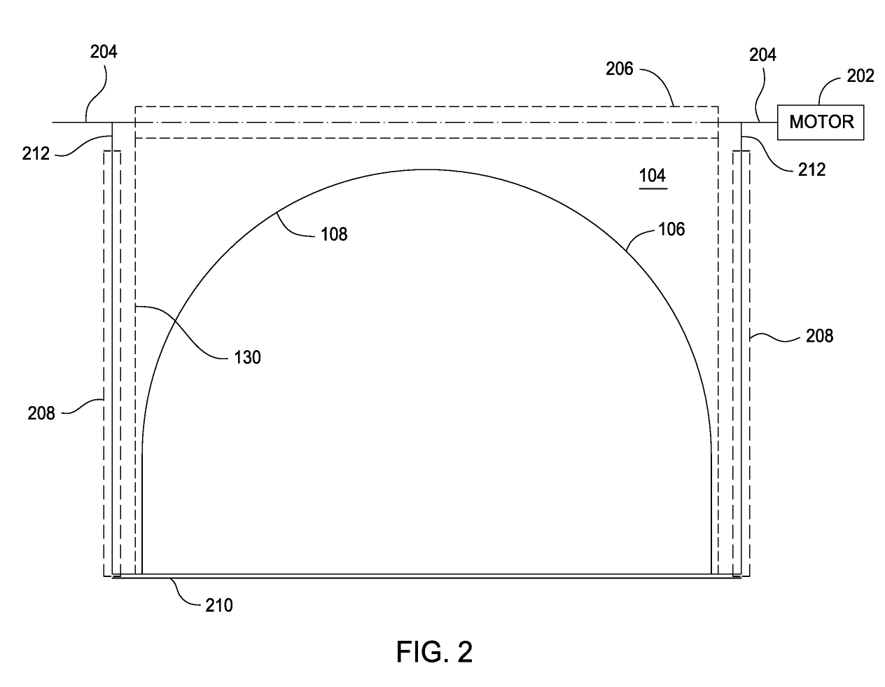

FIG. 2 illustrates a side view of one of the wheel wells 106 of the vehicle 100, wherein the pliable fender skirt 130 is illustrated in a deployed state. In at least one embodiment, the pliable fender skirt 130, and mechanisms for actuating the pliable fender skirt 130, are positioned at an inward facing surface of the fairing 102. As such, in FIG. 2, the pliable fender skirt 130 is illustrated in broken line. A bottom of the pliable fender skirt 130 is attached to a drawbar 210 that can retain the pliable fender skirt 130 at or toward a bottom of the wheel well 106. Ends of the drawbar 210 are directed along guides 208 (e.g., rails or channels) between the bottom of the wheel well 106 and the top of the wheel well 106. A top of the pliable fender skirt 130 is arranged on a roll 206. The roll 206 is attached to an output shaft 204 of the motor 202 (e.g., an electric motor). The motor 202 is in communication with the controller 120 (illustrated in FIGS. 1A and 1B) and rotates in response to command signals from the controller 120. The motor 202 rotates in a first direction to wind the pliable fender skirt 130 about the roll 206 and rotates in a second opposite direction to unwind the pliable fender skirt 130 from the roll 206. As the pliable fender skirt 130 is unwound from the roll 206, the drawbar 210 moves downwardly along the guides 208. As a pliable fender skirt 130 is wound onto the roll 206, the drawbar 210 moves upwardly along guides 208.

In one embodiment, gravity forces acting on the drawbar 210 and the pliable fender skirt 130 pull the drawbar 210 (and attached pliable fender skirt 130) downwardly along the guides 208 as the pliable fender skirt 130 is unwound from the roll 206. In at least one embodiment, drawbar drivers 212 (e.g., belts, chains, cables, or ropes) are coupled to the drawbar 210 and to the output shaft 204 of the motor. For example, in one embodiment, the drawbar drivers 212 are belts that are wound around the output shaft 204 of the motor and about a pulley or bushing toward the bottom of the guides 208. When the motor 202 and the output shaft 204 turn, the belts also rotate. The ends of the drawbar 210 are connected to the belts such that the movement of the belts moves the drawbar 210 upwardly or downwardly, depending on the direction of rotation of the motor 202 and the output shaft 204.

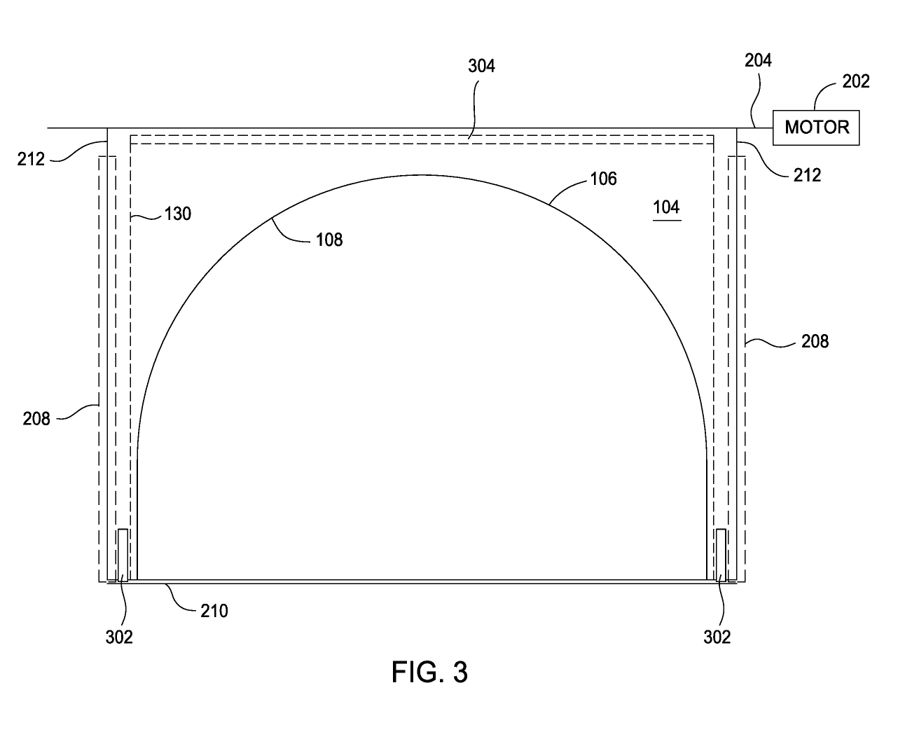

FIG. 3 illustrates another embodiment of an actuating mechanism for the pliable fairing skirt 130. In this embodiment, the pliable fairing skirt 130 comprises a resilient material, such as rubber, that can be placed in tension to cause the material to stretch and will return to its original shape and size upon release of the tension. In the embodiment illustrated in FIG. 3, the top of the pliable fender skirt 130 is attached to a frame 304 disposed above the wheel well 106. The frame 304 may be a clamp or a series of rivets or other fasteners that hold the top of the pliable fairing skirt 130 in place. The bottom of the pliable fairing skirt 130 is attached to the drawbar 210. As described above with reference to FIG. 2, the drawbar is movable between the bottom of the wheel well 106 in the top of the wheel well 106 via drawbar drivers 212, which are rotated by the output shaft 204 of the motor 202. The motor 202 is operated by the controller 120 to move the drawbar 210 toward the bottom of the wheel well 106, as illustrated in FIG. 3. As the drawbar 210 moves toward the bottom of the wheel well 106, the pliable fender skirt 130 is stretched over the opening 108 of the wheel well 106. Upon reaching the bottom of the wheel well 106, the drawbar 210 is held in place by latches 302, and the drawbar 210, in turn, holds the pliable fender skirt 130 in the stretched state over the opening 108 of the wheel well 106. The latches include solenoids or other electrically controlled release elements that are in communication with the controller 120. When the controller 120 commands the latches 302 to release the drawbar 210, the tension stored in the stretched pliable fender skirt 130 causes the pliable fender skirt 130 shrink toward its un-stretched size. As a result, the pliable fender skirt 130 and the drawbar 210 are drawn upwardly toward the frame 304 such that the pliable fairing skirt 130 does not cover the opening 108 of the wheel well 106. When the controller 120 commands the latches 302 to release the drawbar 210, the controller 120 could also command the motor 202 and/or the output shaft 204 to freewheel so that the output shaft 204 and drawbar drivers 212 do not impede movement of the drawbar 210 toward the top of the wheel well 106.

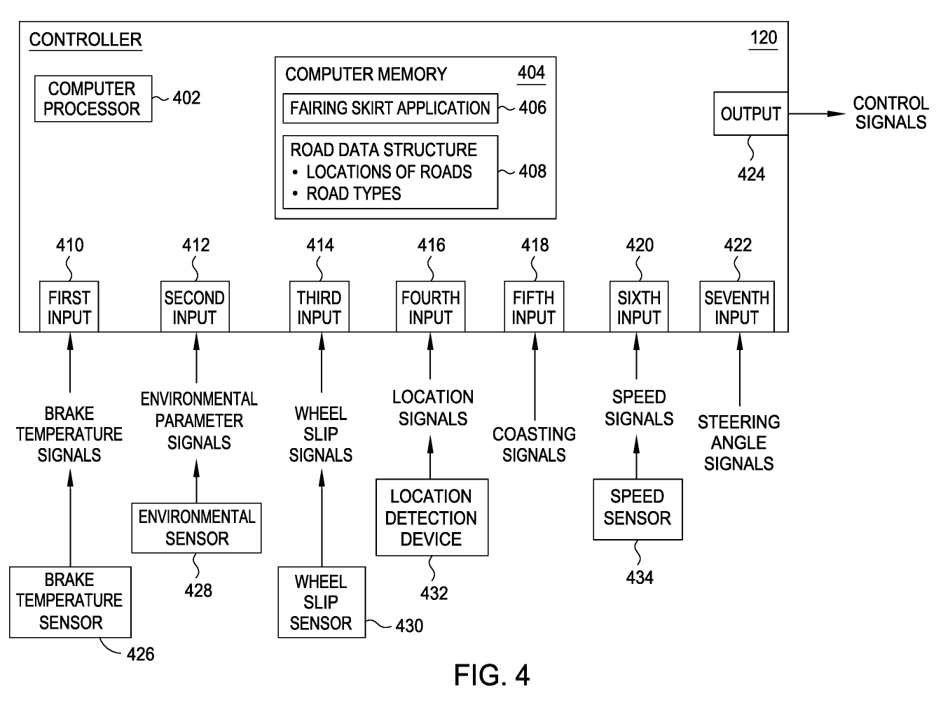

FIG. 4 is a block diagram of at least one embodiment of the controller 120 that controls movement of the pliable fender skirt 130. The controller 120 includes a computer processor 402 and computer memory 404. The computer memory stores a fairing skirt application 406 that is executable by the computer processor 402 to analyze signals from one or more inputs to determine whether the pliable fairing skirts 130 should be in a stowed state, a deployed state, or a states between the stowed stage and the deployed state. The fairing skirt application 406 is also executable to output control signals to cause the pliable fairing skirts 130 move between the deployed state in the stowed state.

In at least one embodiment, the controller 120 includes a first input 410 operable to receive brake temperature signals from a brake temperature sensor 426. The brake temperature sensor 426 could measure the temperature of a disk 114 and/or caliper 116 of a wheel 110 of the vehicle 100. The fairing skirt application 406 could compare the temperature indicated by the received brake temperature signals to a threshold temperature. Upon the temperature exceeding the threshold temperature, the fairing skirt application 406 could output control signals via an output 424 to cause the pliable fairing skirt to move from a deployed state toward a stowed state to provide additional cooling airflow to the brakes.

In at least one embodiment, the controller 120 includes a second input 412 that receives environmental parameter signals from at least one environmental sensor 428. The fairing skirt application 406 is further executable by the computer processor 402 to identify environmental conditions corresponding to the received environmental parameter signals. For example, in one embodiment, the second input 412 includes an environmental temperature input operable to receive environmental temperature signals from an environmental temperature sensor and a moisture input operable to receive moisture signals from a moisture sensor. For example, the environmental temperature sensor could measure an ambient air temperature and the moisture sensor could measure a humidity level. In such an embodiment, the fairing skirt application 406 could determine that a freezing water condition (e.g., ice and/or snow) exists upon the environmental temperature sensor signals indicating temperatures below the freezing temperature of water and upon the moisture sensor signals indicating a presence of at least one of liquid water or frozen water. The fairing skirt application 406 is further executable by the computer processor 402 to output control signals via the output 424 to cause the pliable fairing skirt 130 move from the deployed state toward the stowed state upon determining that the freezing water condition exists to reduce the chances of the pliable fairing skirt 130 being damaged by snow and/or ice and also to prevent snow and/or ice from being trapped between the wheel 110 and the pliable fairing skirt 130.

In at least one embodiment, the controller 120 includes a third input 414 that receives wheel slip signals from a wheel slip sensor 430. In such embodiments, the fairing skirt application 406 is further executable on the computer processor 402 to identify wheel slip based on the received wheel slip signals. For example, one or more wheels 110 of the vehicle 100 may slip if the vehicle 100 is moving on a loose surface, such as a gravel road, dirt road, sand, or snow. The slipping wheels could throw road debris, such as gravel, at the pliable fender skirts 130, potentially damaging the pliable fender skirts 130. Additionally, such materials could clog the wheel wells 106 if the pliable fender skirts 130 are in the deployed state. Accordingly, the fairing skirt application 406 is operable to send command signals via the output 424 to move the pliable fairing skirts 130 from the deployed state toward the stowed state upon identifying wheel slip.

In at least one embodiment, the controller 120 includes a fourth input 416 operable to receive location signals from a location detection device 432, such as a global positioning system (GPS) receiver. Additionally, in this embodiment, the computer memory 404 stores a data structure of roads 408 that includes the locations of roads (e.g., latitudes and longitudes associated with roads) and indications of road types of the roads (e.g., paved, gravel, or dirt). The fairing skirt application 406 is further executable by the computer processor 402 to determine whether the received location signals from the location detection device 432 corresponds to a location of a road and, if so, a road type of the road. Upon determining that the location signals do not correspond to a location of a road or that the location signals correspond to a road having an unpaved road type, the fairing skirt application 406 commands the pliable fairing skirt 130 (command signals sent via the output 424) to move from the deployed state toward the stowed state. Again, unpaved roads are more likely to include loose debris, such as rocks or dirt, that could damage the pliable fender skirts 130 and/or clog the wheel wells 106, so the controller 120 moves the pliable fender skirts 130 to the stowed states to prevent such damage or clogging.

The controller 120 may store a programmed route in the computer memory 404 and uses the location signals to determine the vehicle's position along, or relative to, the programmed route. In some embodiments, the controller 120 determines an upcoming portion of the programmed route (e.g., based on the location signals), and the fairing skirt application 406 determines whether to deploy or stow the pliable fairing skirt 130 based on the upcoming portion of the programmed route. For example, the fairing skirt application 406 may determine to deploy or stow the pliable fairing skirt 130 based on one or more properties of the upcoming portion. Some non-limiting examples of the one or more properties are: (i) whether the upcoming portion includes any turns from the current road, (ii) a distance and/or time from a current location of the vehicle to a turn in the upcoming portion, (iii) how many turns are included in the upcoming portion, (iv) whether the upcoming portion includes stop(s) or other significant slowdown(s) (e.g., based on traffic conditions), (v) a number of high-speed sections of the road(s) within the upcoming portion, (vi) a proportion of high-speed section(s) within the upcoming portion, and so forth.

At least one embodiment, the controller 120 includes a fifth input 418 that is operable to receive coasting signals. The vehicle 100 may be considered to be coasting if the vehicle is able to maintain or increase speed without the application of throttle. For example, uncertain mountainous routes in which the vehicle 100 may travel along a downhill stretch, a driver may not have to apply any throttle for the vehicle 100 to maintain its speed. In fact, the vehicle 100 may accelerate if the driver does not take steps to keep the speed of the vehicle 100 in check (e.g., by applying the brakes 114 and 116 or by downshifting to a lower gear). In such scenarios, it may be beneficial for the pliable fender skirts 130 move to the stowed state to increase drag on the vehicle 100 and reduce any amount of acceleration. The fairing skirt application 406 could analyze the coasting signals (including a throttle position signal and a speed signal) to determine whether the vehicle is coasting. Alternatively, in certain vehicles 100, the vehicle may completely shut off fuel flow to the engine during such coasting events, and the coasting signals received by the fifth input 418 could include a fuel shutoff command from an engine computer. In the event the vehicle is coasting, the fairing skirt application 406 is further executable on the computer processor 402 to command the pliable fairing skirts 130 move from the deployed state to the stowed state to increase the overall drag on the vehicle 100.

In at least one embodiment, the controller 120 includes a sixth input 420 operable to receive speed signals from a speed sensor 434. The speed sensor 434 could be a speedometer and/or a calculated speed from a GPS receiver, for example. In such embodiments, the fairing skirt application 406 could monitor the speed signals to determine whether a detected speed of travel indicated by the speed signals exceeds a first threshold speed. In the event the detected speed of travel exceeds the first threshold speed, the fairing skirt application 406 is further executable by the computer processor 402 to command the pliable fairing skirts 130 to move from the stowed state to the deployed state. The fairing skirt application 406 could also monitor the speed signals to determine whether the detected speed of travel indicated by the speed signals is below a second threshold speed. In the event the detected speed of travel is below the second threshold speed, the fairing skirt application 406 is further executable by the computer processor 402 to command the pliable fairing skirts 130 to move from the deployed state to the stowed state. Generally, at relatively low speeds (e.g., speeds below 40 mph) the overall aerodynamics of the vehicle 100 may have a relatively small effect on fuel economy such that use of the pliable fender skirts 130 may not be worth any damage the pliable fender skirts 130 may experience from road debris. Additionally, at such lower speeds, a driver may use larger steering inputs then at higher speeds, and such larger steering inputs may result in the steerable wheels of the vehicle (e.g., the front wheels 110a) protruding from the wheel wells 106 through the respective openings 108. As a consequence, the protruding portions of the steerable wheels may contact and damage the pliable fender skirts 130. Therefore, moving the pliable fender skirts 130 to the stowed state when the vehicle 100 is traveling at such lower speeds may be prudent. As the speeds of the vehicle increase (e.g., to speeds at or above 55 mph), the overall aerodynamics of the vehicle 100 have a relatively large effect on fuel economy such that use of the pliable fender skirts 130 is beneficial. In one embodiment, the first threshold speed above which the fairing skirt application 406 moves the pliable fairing skirts 130 from the stowed state to the pliable state maybe higher than the second threshold speed below which the fairing skirt application 406 moves the pliable fairing skirts 130 from the deployed state to the stowed state. In another embodiment, the first threshold speed and the second threshold speed may be the same speed. In yet another embodiment, the second threshold speed maybe higher than the first threshold speed.

In at least one embodiment, the controller 120 includes a seventh input 422 operable to receive steering angle signals. The steering angle signals could be provided by a sensor measuring degrees of turning of the steering wheel of the vehicle, measuring a linear displacement of a rack and pinion steering actuator, or measuring an angular displacement of a steerable wheel, for example. The fairing skirt application 406 can compare a steering angle indicated by the steering angle signals to a threshold steering angle. The threshold steering angle corresponds to a steering angle at which a steerable wheel will protrude from the wheel well through the opening 108 such that the steerable wheel could contact the pliable fender skirt 130. In the event the steering angle indicated by the steering angle signals exceeds the threshold steering angle, the fairing skirt application 406 is further executable on the computer processor 402 to command the pliable fender skirts 130 to move to the stowed state.

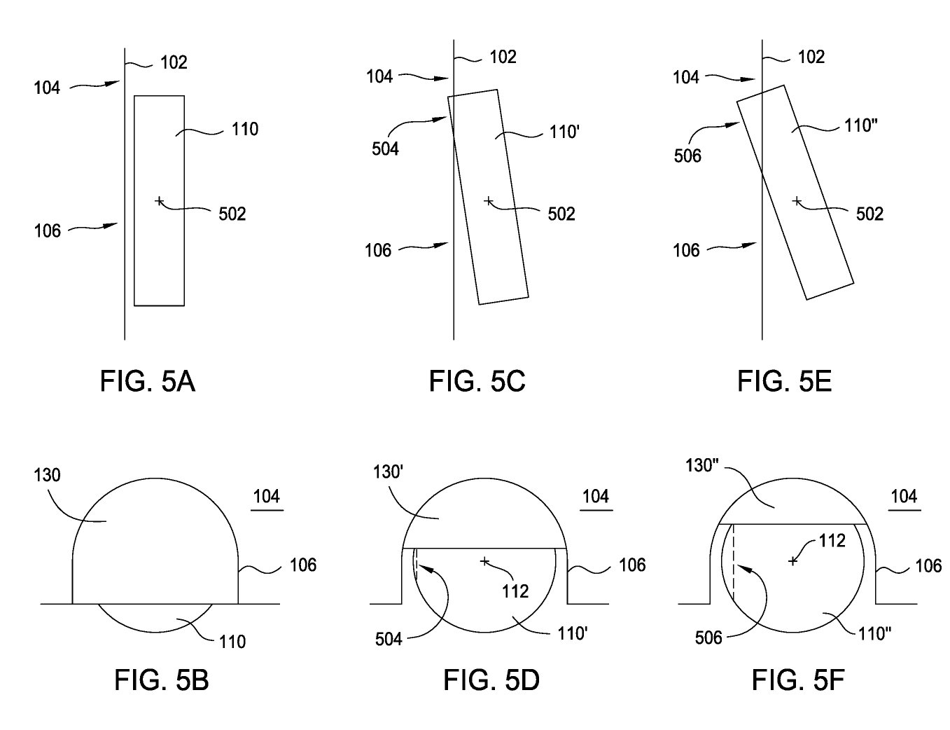

In at least one embodiment, the controller 120 only moves the pliable fender skirts 130 toward the stowed state by an amount necessary to avoid contact with a steerable wheel protruding from the wheel well 106, based on the steering angle indicated by the steering angle signals. FIG. 5A illustrates a steerable wheel 110 that is not turned about a steering axis 502 such that the vehicle 100 travels straight ahead. Accordingly, the wheel 110 does not protrude from the wheel well 106 past the outward-facing surface 104 of the fairing 102. Referring to FIG. 5B, as a result, the pliable fairing skirt 130 can be in the fully deployed position. FIG. 5C illustrates the steerable wheel 110 pivoted about the steering axis 502 by a first amount such that a portion of the wheel 110 protrudes from the wheel well 106 past the outward-facing surface 104 of the fairing 102. A portion 504 of the wheel 110 horizontally aligned with the rotation axis 112 of the wheel 110 is the first to protrude from the wheel well 106. Referring to FIG. 5D, as a result, the pliable fender skirt 130′ is moved to a partially deployed state (or a partially stowed state), wherein the bottom of the pliable fender skirt 130′ (e.g., the drawbar 210) is positioned above the portion 504 of the wheel 110 protruding from the wheel well 106. FIG. 5E illustrates the steerable wheel 110 pivoted about the steering axis 502 by a second amount, which is greater than the first amount. As a result, a greater portion 506 of the wheel 110 protrudes from the wheel well 106 past the outward-facing surface 104 of the fairing 102. Referring to FIG. 5F, as a result, the pliable fender skirt 130″ is moved to a lesser partially deployed state (or a greater partially stowed state) then as shown in FIG. 5D, wherein the bottom of the pliable fender skirt 130″ is positioned above the greater portion 506 of the wheel 110 protruding from the wheel well 106. In at least one embodiment, the controller 120 may store a lookup table or similar data structure that indicates the portion of the wheel 110 protruding from the wheel well 106 for different degrees of pivoting about the steering axis 502. The controller 120 may use such a lookup table or similar data structure to move the pliable fender skirts 130 positions such that the bottoms of the pliable fender skirts 130 are positioned above the portions of the wheels 110 protruding from the wheel wells 106 for a given pivot angle.

In various embodiments, the controller 120 could include any combination of the first input 410, second input 412, third input 414, fourth input 416, fifth input 418, sixth input 420, and seventh input 422.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A vehicle, comprising:
a fairing that includes an outward-facing surface and defines a wheel well, wherein an opening in the fairing forms a pathway between the outward-facing surface and the wheel well;
a wheel disposed in the wheel well, wherein the wheel is operatively connected to a brake, and wherein the wheel is rotatable about a rotation axis to move the vehicle;
a pliable fairing skirt that is movable between a stowed state and a deployed state, wherein the pliable fairing skirt is stored above the opening and behind the outward-facing surface of the fairing in the stowed state, and wherein the pliable fairing skirt covers at least a portion of the opening in the deployed state;
an actuator operable to move the pliable fairing skirt between the stowed state and the deployed state;
a brake temperature sensor operable to detect temperatures of the brake; and
a controller in communication with the actuator and with the brake temperature sensor, wherein the controller is operable to move the pliable fairing skirt from the deployed state toward the stowed state upon receiving a signal from the brake temperature sensor indicating a brake temperature that exceeds a temperature threshold.

2. The vehicle of claim 1, further comprising at least one environmental sensor operable to detect an environmental parameter, wherein the controller is in communication with the at least one environmental sensor, and wherein the controller is operable to move the pliable fairing skirt from the deployed state toward the stowed state upon receiving a signal from the at least one environmental sensor indicating an environmental condition that could result in damage to the pliable fairing skirt.

3. The vehicle of claim 2, wherein the at least one environmental sensor comprises a temperature sensor and a moisture sensor, wherein the controller is operable to determine that the temperature sensor, wherein the moisture sensor is operable to indicate an environmental condition of freezing water upon the temperature sensor detecting temperatures below the freezing temperature of water and upon the moisture sensor detecting at least one of liquid water or frozen water, and wherein the controller is operable to move the pliable fairing skirt from the deployed state toward the stowed state upon receiving the indication of freezing water.

4. The vehicle of claim 1, further comprising at least one wheel slip sensor operable to detect slipping of the wheel over a ground surface, wherein the at least one wheel slip sensor is in communication with the controller, and wherein the controller is operable to move the pliable fairing skirt from the deployed state toward the stowed state upon receiving a signal indicating wheel slip from the at least one wheel slip sensor.

5. The vehicle of claim 1, further comprising:
at least one location detection device operable to determine a location of the vehicle in communication with the controller, and wherein the controller is further operable to:
store a programmed route;
determine, using the location signals, an upcoming portion of the programmed route; and
determine, based on one or more properties of the upcoming portion, whether to move the pliable fairing skirt toward the stowed state or toward the deployed state.

6. The vehicle of claim 1, wherein the controller is operable to determine that the vehicle is coasting along a downward incline, and wherein the controller is operable to move the pliable fairing skirt from the deployed state toward the stowed state upon determining that the vehicle is coasting along the downward incline.

7. The vehicle of claim 1, further comprising a speed sensor in communication with the controller and operable to detect a speed of travel of the vehicle, wherein the controller is operable to move the pliable fairing skirt from the stowed state to the deployed state upon the detected speed of travel exceeding a first threshold speed, and wherein the controller is operable to move the pliable fairing skirt from the deployed state toward the stowed state upon the speed of travel decreasing below a second threshold speed.

8. The vehicle of claim 1, wherein the wheel is pivotable about a steering axis to steer the vehicle, wherein the wheel protrudes through the opening in the outward-facing surface of the fairing when the wheel is pivoted from a neutral orientation by more than a threshold degree, and wherein the controller is operable to move the pliable fairing skirt from the deployed state toward the stowed state upon the wheel pivoting by an amount equal to or greater than the threshold degree.

9. The vehicle of claim 8, wherein the wheel protrudes through a middle portion of the opening between the top and bottom when pivoted by the threshold amount and protrudes through increasingly higher portions of the opening when pivoted by increasing degrees, and wherein the controller is operable to move the pliable fairing skirt from the deployed state to an intermediate stated based upon the degree by which the wheel is pivoted such that a bottom of the pliable fairing skirt is above the protruding portion of the wheel.

10. The vehicle of claim 1, wherein the pliable fairing skirt comprises one of a rubber sheet, Kevlar sheet, or a plastic sheet.

11. The vehicle of claim 1, wherein the pliable fairing skirt is stretched and held in tension in the deployed state, and wherein moving the pliable fairing skirt to the stowed position comprises releasing the tension such that the pliable fairing skirt contracts to the stowed position.

12. A controller operable to selectively deploy a pliable fairing skirt over an opening for wheel well in a vehicle fairing, the controller comprising:
a first input operable to receive temperature signals from a brake temperature sensor;
an output operable to transmit control signals to the pliable fairing skirt to cause the pliable fairing skirt to move toward a deployed state and a stowed state;
a computer processor; and
computer memory storing an application that, when executed by the computer processor, performs an operation, comprising:
comparing a temperature indicated by the temperature signals to a threshold temperature; and
outputting control signals to cause the pliable fairing skirt to move from the deployed state toward the stowed state upon the temperature indicated by the temperature signals exceeding the threshold temperature.

13. The controller of claim 12, further comprising:
a second input operable to receive environmental parameter signals from at least one environmental sensor, and
wherein the application performs additional operations, comprising:
identifying environmental conditions corresponding to the received environmental parameter signals; and
outputting control signals to cause the pliable fairing skirt to move from the deployed state toward the stowed state upon identifying environmental conditions that could result in damage to the pliable fairing skirt.

14. The controller of claim 13, wherein the second input comprises an environmental temperature input operable to receive environmental temperature signals from a temperature sensor and a moisture input operable to receive moisture signals from a moisture sensor, and
wherein the application performs additional operations, comprising:
determining that a freezing water condition exists upon the environmental temperature signals indicating temperatures below the freezing temperature of water and upon the moisture signals indicating a presence of at least one of liquid water or frozen water; and
outputting control signals to cause the pliable fairing skirt to move from the deployed state toward the stowed state upon determining that the freezing water condition exists.

15. The controller of claim 12, further comprising:
a second input operable to receive wheel slip signals from at least one wheel slip sensor, and
wherein the application performs additional operations, comprising:
identifying wheel slip based on the received wheel slip signals; and
moving the pliable fairing skirt from the deployed state toward the stowed state upon identifying wheel slip.

16. The controller of claim 12, further comprising:
a second input operable to receive location signals from a location detection device, and
wherein the computer memory is configured to store a programmed route, and wherein
the application performs additional operations, comprising:
determining, using the location signals, an upcoming portion of the programmed route; and
determining, based on one or more properties of the upcoming portion,
whether to move the pliable fairing skirt toward the stowed state or toward the deployed state.

17. The controller of claim 12, further comprising:
a second input operable to receive coasting signals from a vehicle, and wherein the application performs additional operations, comprising moving the pliable fairing skirt from the deployed state toward the stowed state upon receiving the coasting signals from the vehicle.

18. The controller of claim 12, further comprising:
a second input operable to receive speed signals from a speed sensor, and
wherein the application performs additional operations, comprising:
moving the pliable fairing skirt from the stowed state to the deployed state upon the detected speed of travel exceeding a first threshold speed, and
moving the pliable fairing skirt from the deployed state toward the stowed state upon the speed of travel decreasing below a second threshold speed.

19. The controller of claim 12, further comprising:
a second input operable to receive steering angle signals, and
wherein the application performs additional operations, comprising moving the pliable fairing skirt from the deployed state toward the stowed state upon the steering angle signals indicating a steering angle equal to or greater than a threshold steering angle.

20. The controller of claim 19, moving the pliable fairing skirt from the deployed state toward the stowed state upon the steering angle signals indicating a steering angle equal to or greater than a threshold steering angle comprises moving the pliable fairing skirt from the deployed position toward the stowed position by an amount proportional to the indicated steering angle.
